(19) United States
(12) Patent Application Publication
(10) Pub. No.: US 2018/0205660 A1
(43) Pub. Date: Jul. 19, 2018

(54) APPARATUS AND METHOD FOR CONTROLLING USAGE OF A NON-OPTIMAL PATH

(71) Applicant: Futurewei Technologies, Inc., Plano, TX (US)

(72) Inventors: Hang Shi, Fremont, CA (US); Yinghua Ye, Los Gatos, CA (US); Huida Dai, Cupertino, CA (US)

(21) Appl. No.: 15/410,641

(22) Filed: Jan. 19, 2017

(51) Int. Cl. H04L 12/841; H04L 12/26

(52) U.S. Cl. CPC H04L 47/283; H04L 69/16; H04L 43/0864

(57) ABSTRACT

An apparatus, method, and non-transitory computer-readable media are provided for controlling usage of an non-optimal path. In use, for example, a processing device identifies one of a plurality of paths as an optimal path based on a plurality of round trip time (RTT) values, where the RTT values include an optimal path round trip time (RTT) value of the optimal path and at least one non-optimal path RTT value of at least one non-optimal path. A threshold data amount is determined in connection with the at least one non-optimal path, based on the optimal path RTT value of the optimal path and the at least one non-optimal path RTT value of the at least one non-optimal path. Further, an application data amount is estimated by the processing device in connection with messages of at least one application. Such application data amount and threshold data amount are compared by the processing device. To this end, usage of the at least one non-optimal path is controlled by the processing device for communicating the messages of the at least one application, based on the comparison of the application data amount and the threshold data amount.

### FIELD OF THE INVENTION

The present invention relates to networking, and more particularly to communicating data utilizing multiple paths.

### BACKGROUND

Single path packet switching is a type of switching that communicates data from a source to a destination using a single path (e.g. connection, etc.). In contrast, multipath packet switching refers to a type of switching that allows for the use of multiple paths (e.g. connections, etc.) when communicating data from the source to the destination. For larger data flows, multipath packet switching is superior to single path packet switching, since there is more bandwidth for enabling faster delivery of data from the source to the destination.

However, for smaller data flows, multipath packet switching can actually offer a disadvantage with respect to single path packet switching. Specifically, setting up each of the paths to support multipath packet switching requires a considerable amount of handshake signaling, etc. Further, in some situations, a cost of such setup processing may outweigh a benefit (if any) arising from an availability of more paths to deliver data from the source to the destination.

For example, situations exist where a time necessary for setting up one or more additional paths is greater than a time it would otherwise take to deliver a smaller data flow to the destination via a single path. In such situation, resources spent on setting up the additional path(s) (and tearing down the same) are wasted since the additional path(s) is not even used.

### SUMMARY

An apparatus, method, and non-transitory computer-readable media are provided for controlling usage of a non-optimal path.

An apparatus is provided for controlling usage of a non-optimal path. Included is a non-transitory memory storing instructions, and a plurality of round trip time (RTT) values of a plurality of paths. Further included are one or more processors in communication with the non-transitory memory. The one or more processors execute the instructions to identify one of the plurality of paths as an optimal path, based on the plurality of RTT values. Once the optimal path is identified (versus the non-optimal paths), the RTT values are known to include an optimal path RTT value of the optimal path and at least one non-optimal path RTT value of at least one non-optimal path. A threshold data amount is determined in connection with the at least one non-optimal path, based on the optimal path RTT value of the optimal path and the at least one non-optimal path RTT value of the at least one non-optimal path. Further, an application data amount is estimated in connection with messages of at least one application. Such application data amount and threshold data amount are compared. To this end, usage of the at least one non-optimal path is controlled for communicating the messages of the at least one application, based on the comparison of the application data amount and the threshold data amount.

Also provided is a method for controlling usage of a non-optimal path. In use, a processing device identifies one of a plurality of paths as an optimal path based on a plurality of round trip time (RTT) values, where the RTT values include an optimal path round trip time (RTT) value of the optimal path and at least one non-optimal path RTT value of at least one non-optimal path. A threshold data amount is determined in connection with the at least one non-optimal path, based on the optimal path RTT value of the optimal path and the at least one non-optimal path RTT value of the at least one non-optimal path. Further, an application data amount is estimated by the processing device in connection with messages of at least one application. Such application data amount and threshold data amount are compared by the processing device. To this end, usage of the at least one non-optimal path is controlled by the processing device for communicating the messages of the at least one application, based on the comparison of the application data amount and the threshold data amount.

A non-transitory computer-readable media storing computer instructions is also provided, that when executed by one or more processors, cause the one or more processors to perform the steps of identifying one of a plurality of paths as an optimal path based on a plurality of round trip time (RTT) values, where the RTT values include an optimal path round trip time (RTT) value of the optimal path and at least one non-optimal path RTT value of at least one non-optimal path; determining a threshold data amount in connection with the at least one non-optimal path, based on the optimal path RTT value of the optimal path and the at least one non-optimal path RTT value of the at least one non-optimal path; estimating an application data amount in connection with messages of at least one application; comparing the application data amount and the threshold data amount; and controlling usage of the at least one non-optimal path for communicating the messages of the at least one application, based on the comparison of the application data amount and the threshold data amount.

In some processing device, method, or computer-readable media embodiments, the determination of the threshold data amount for the at least one non-optimal path may be further based on information on the at least one application.

In some processing device, method, or computer-readable media embodiments, the application data amount may be estimated utilizing at least one of pattern learning or a condition of a transport control protocol (TCP) receiver buffer.

In some processing device, method, or computer-readable media embodiments, the usage of the at least one non-optimal path may be controlled by: setting up the at least one non-optimal path, and/or terminating the at least one non-optimal path.

In some processing device, method, or computer-readable media embodiments, the application data amount may be updated, where the control of the usage of the at least one non-optimal path may also be updated, based on the updated application data amount.

In some processing device, method, or computer-readable media embodiments, the threshold data amount may be updated, where the control of the usage of the at least one non-optimal path may also be updated, based on the updated threshold data amount.

In some processing device, method, or computer-readable media embodiments, the threshold data amount may be updated based on at least one updated optimal path RTT value of the optimal path and at least one updated non-optimal path RTT value of the non-optimal path.

In some processing device, method, or computer-readable media embodiments, the RTT values of the plurality of paths may be set based on a policy.

In some processing device, method, or computer-readable media embodiments, the RTT values of the plurality of paths may be set by at least one other application which has used at least one of the plurality of paths.

In some processing device, method, or computer-readable media embodiments, the threshold data amount may be determined by: calculating a non-optimal path setup time for the at least one non-optimal path based on the at least one non-optimal path RTT value of the at least one non-optimal path; identifying an optimal path bandwidth of the optimal path; and determining the threshold data amount to be at least an amount of data that is capable of being communicated utilizing the optimal path during the non-optimal path setup time.

One or more of the foregoing features may allow for selectively avoiding use of a non-optimal path in situations where there is insufficient application data to be communicated, in order to justify setting up such non-optimal path. This may, in turn, result in a conservation of resources that would otherwise be foregone in systems that lack such feature. It should be noted that the aforementioned potential advantages are set forth for illustrative purposes only and should not be construed as limiting in any manner.

### BRIEF DESCRIPTION OF THE DRAWINGS

FIG. 1 illustrates a path control system for controlling usage of at least one non-optimal path, in accordance with an embodiment.

FIG. 2 is a flowchart of a method for controlling usage of at least one non-optimal path, in accordance with an embodiment.

FIG. 3 is a flowchart of a method for determining a threshold data amount, in accordance with an embodiment.

FIG. 4 illustrates a connection set up process involving an optimal path and a non-optimal path involving having parameters including round trip time (RTT) values that are used for determining a threshold data amount in accordance with the method of FIG. 3.

FIG. 5 is a flowchart of a method for estimating an amount of data that will be communicated by an application, in accordance with an embodiment.

FIG. 6A illustrates a first system in which usage of a non-optimal path may be controlled, in accordance with an embodiment.

FIG. 6B illustrates a second system in which usage of a non-optimal path may be controlled, in accordance with another embodiment.

FIG. 6C illustrates a third system in which usage of a non-optimal path may be controlled, in accordance with yet another embodiment.

FIG. 7 illustrates a system for controlling usage of at least one non-optimal path, in accordance with an embodiment.

FIG. 8 is a diagram of a network architecture, in accordance with an embodiment.

FIG. 9 is a diagram of an exemplary processing device, in accordance with an embodiment.

### DETAILED DESCRIPTION

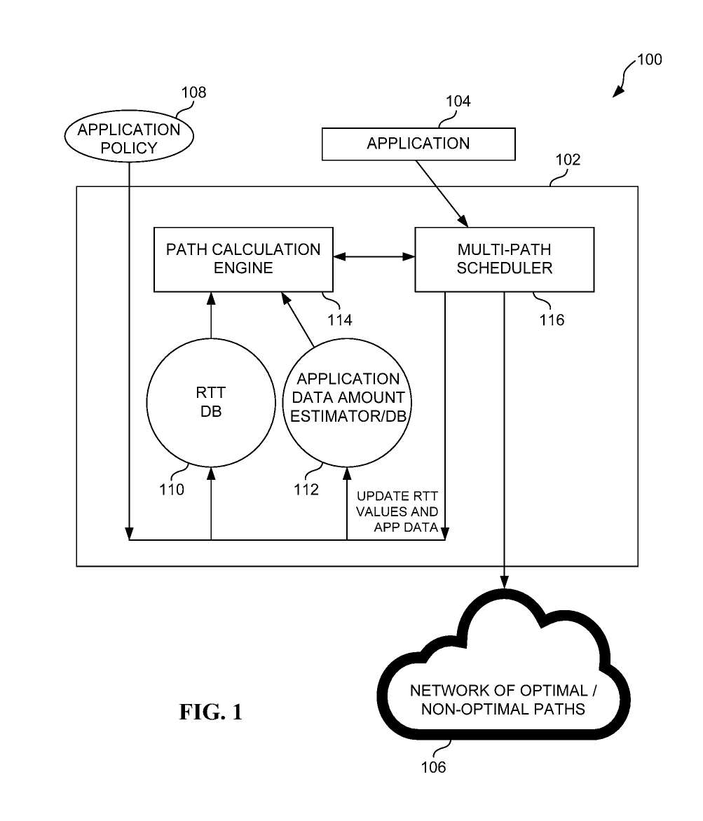

FIG. 1 illustrates a path control system 100 for controlling usage of at least one non-optimal path, in accordance with an embodiment. As shown, the path control system 100 includes a path controller apparatus 102 coupled between an application 104 and a network 106 including a plurality of paths that will be classified to include an optimal path and one or more non-optimal paths, in a manner that soon will become apparent. In the context of the present description, such application 104 may include any software capable of causing messages to be communicated over the network 106. For example, in one embodiment, such messages may be configured for being communicated utilizing a transmission control protocol/Internet Protocol (TCP/IP) via the Internet. In other embodiments, other protocols [e.g. Internet control message protocol (ICMP), user datagram protocol (UDP), etc.] and other networks (e.g. personal area, local area, wide area, etc.) are contemplated.

Still yet, the aforementioned paths of the network 106 may include one or more connections over which messages of (e.g. to and/or from) the application 104 may be communicated. Further, an optimal path may be identified as any one of the aforementioned paths whose use results in optimal (e.g. fastest, most efficient and/or effective, etc.) communication of the foregoing messages, as compared to other path(s). For example, in one embodiment, such optimal path may be identified, based on a plurality of RTT values associated with a plurality of paths. Specifically, one of the paths that has the smallest RTT value(s) may be designated as the optimal path, while the remaining paths may be designated as non-optimal paths. To this end, after such optimal/non-optimal path designation, the RTT values may include an optimal path RTT value of the optimal path and one or more non-optimal path RTT values of one or more non-optimal paths.

As will soon become apparent, such optimal path is selected as a default path to communicate messages of the application 104, and further processing is carried out to determine whether use of one or more non-optimal paths (in combination with the optimal path) would result in faster data communication when taking into account an amount of time it takes to setup the non-optimal path(s).

With continuing reference to FIG. 1, the path controller apparatus 102 further receives one or more application policies 108 for reasons that will become apparent later. In use, the path controller apparatus 102 controls, under the direction of the application policies 108, which paths of the network 106 are used to communicate messages (e.g. from the application 104 to an appropriate destination through or in the network 106). Specifically, in one embodiment, the path controller apparatus 102 determines which, if any, non-optimal path should be used in combination with an optimal path, for communicating the messages from the application 104 using a multi-path approach.

To accomplish this, the path controller apparatus 102 includes a RTT value database 110 that stores RTT values for each of the paths of the network 106, and an application data amount estimator/database 112 for estimating an amount of data that is to be communicated by the application 104 and further store such estimated application data amounts. Still yet, the path controller apparatus 102 further includes a path calculation engine 114 that is in communication with the RTT value database 110 and the application data amount estimator/database 112 for receiving the aforementioned information therefrom. The path controller apparatus 102 also remains in communication with a multi-path scheduler 116 that is coupled between the application 104 and the network 106. Under the direction of the path calculation engine 114, the multi-path scheduler 116 controls usage of the various the optimal/non-optimal paths of the network 106 for communicating messages of the application 104 over the network 106. Further, the multi-path scheduler 116 serves to update the RTT value database 110 and the application data amount estimator/database 112, as shown.

By this design, the path calculation engine 114 and the multi-path scheduler 116 cooperate to use the RTT values of the RTT value database 110 to determine an amount of data representing a threshold that, below which, indicates a situation where usage of a non-optimal path (in combination with an optimal path) does not make sense since such data amount may be communicated via the optimal path before the non-optimal path is even setup. In other words, it would take longer to setup the non-optimal path than to simply send all of the data via the optimal path. Conversely, if an amount of data to be communicated by the application 104 is greater than the threshold data amount, such is indicative of a situation where it does indeed make sense to setup the non-optimal path, since, even after taking into account the non-optimal path setup time, use of the non-optimal path (to communicate at least some of the data) would result in faster overall data communication.

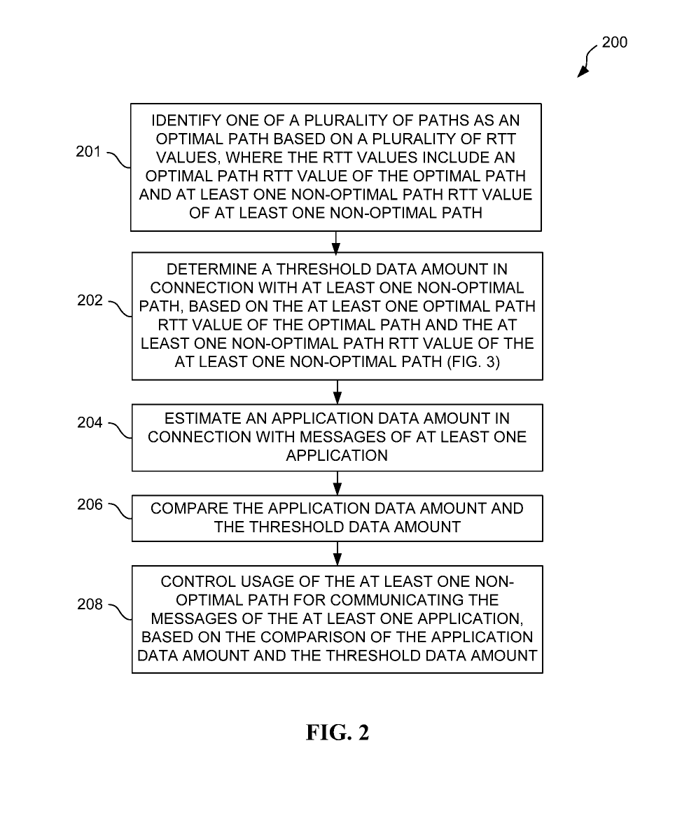

It should be noted that, in some embodiments, the foregoing decision (to use the non-optimal path(s) or not) is made without a priori knowledge of the amount of data that is to be communicated by the application 104. To accommodate this, the path calculation engine 114 and the multi-path scheduler 116 cooperate to use the estimated application data amounts of the application data amount estimator/database 112, by comparing the same to the aforementioned threshold data amount, in order to determine whether use of the non-optimal path(s) would result in faster overall data communication. In embodiments where multiple non-optimal paths exist, the forgoing comparison may be carried out for each non-optimal path, where a separate threshold data amount exists for each non-optimal path. More information regarding one possible way in which such decision may be carried out will now be set forth in the context of a different embodiment shown in FIG. 2.

FIG. 2 is a flowchart of a method 200 for controlling usage of at least one non-optimal path, in accordance with an embodiment. As an option, the method 200 may be implemented in the context of any one or more of the embodiments set forth in any previous and/or subsequent figure(s) and/or the description thereof. For example, the method 200 may, in one possible embodiment, reflect the operation of the path control system 100 of FIG. 1. However, it is to be appreciated that the method 200 may be implemented in the context of any desired environment.

As shown, in step 201, one of a plurality of paths is identified as an optimal path, based on a plurality of RTT values. Once the optimal path is identified (versus non-optimal paths), the RTT values are known to include an optimal path RTT value of the optimal path, and one or more non-optimal path RTT values of one or more non-optimal paths.

Thereafter, in step 202, a threshold data amount is determined in connection with each non-optimal path, based on at least one optimal path RTT value of an optimal path and at least one non-optimal path RTT value of the corresponding non-optimal path. In the context of the present description, the foregoing threshold data amount may include any amount of data that triggers use of a corresponding non-optimal path (in addition to an optimal path), for communicating data via a multi-path approach.

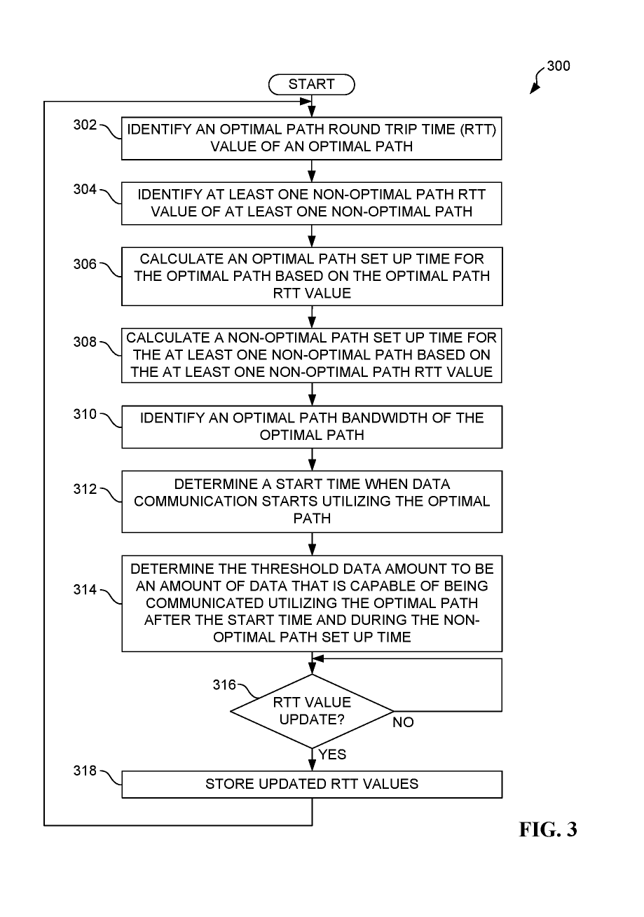

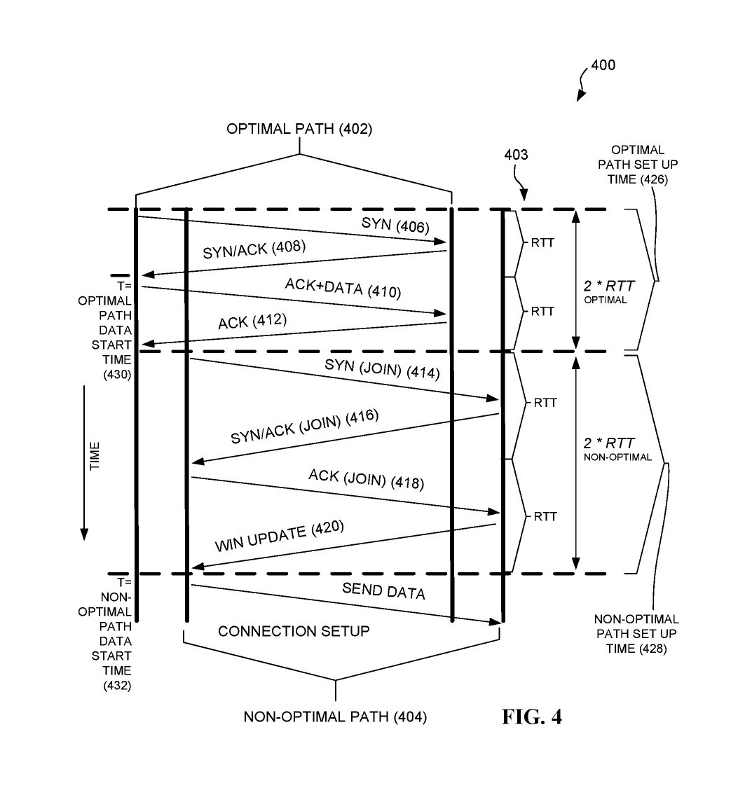

Further, the foregoing RTT values refer to a round-trip delay, that is, a time required for a signal pulse or packet to travel from a specific source to a specific destination and back again. As mentioned earlier during the description of FIG. 1, such RTT values may be used to calculate the threshold data amount which indicates whether it is worthwhile to setup the non-optimal path or not. More information regarding such RTT values and one possible way of determining the threshold data amount will be elaborated upon in the context of different embodiments during the description of FIGS. 3 and 4.

In one possible embodiment, step 202 may be carried out by a corresponding engine (e.g. the path calculation engine of 114 of FIG. 1) using RTT values that are either set by a policy (e.g. the application policy 108 of FIG. 1), or measured by other applications, or monitored during path usage by a scheduler (e.g. the multi-path scheduler 116 of FIG. 1). In any case, it should be noted that any of foregoing components may be implemented as separate or integrated components that comprise any combination of hardware and/or software.

With continuing reference to FIG. 2 and, in particular, step 204, an application data amount is estimated in connection with messages of at least one application (e.g. the application 104 of FIG. 1). In the context of the present description, such application data amount may refer to any amount of data that is to be sent by and/or received from the application(s). Further, as described earlier, such data amount is used to decide, based on the threshold data amount, whether it is faster to simply send the data messages via solely the optimal path versus a combination of the optimal path and the non-optimal path(s) (in view of latencies associated with setting up the non-optimal path(s)).

Specifically, in step 206, the application data amount estimated in step 204 is compared to the threshold data amount determined in step 202. Further, usage of the non-optimal path(s) for communicating the messages of the at least one application is controlled in step 208, based on the comparison of the application data amount and the threshold data amount in step 206. In the context of the present description, such usage control may involve the control of any setup, enablement, activation, use, and/or termination in connection with the non-optimal path(s).

In particular, in accordance with one possible embodiment, if the application data amount is determined in step 206 to be below the threshold data amount, it may be faster to simply use solely the optimal path to communicate the data, as opposed to communicating some of the data via the optimal path while waiting for the non-optimal path to setup, and then communicating data via both paths after such non-optimal path setup process is complete. In other words, by the time the non-optimal path setup process is complete, the data would have already been communicated via the optimal path, thus rendering the non-optimal path setup process a waste of resources. On the other hand, if the application data amount is determined in step 206 to be above the threshold data amount, some of the data may be communicated via the optimal path, while waiting for the non-optimal path to setup, and then communicating the remaining data via both paths after such non-optimal path setup process is complete. In other words, by the time the non-optimal path setup process is complete, there would be additional data to communicate via the non-optimal path.

To this end, some optional embodiments may allow for selectively avoiding use of a non-optimal path in situations where there is insufficient application data to be communicated, in order to justify setting up such non-optimal path. This may, in turn, result in a conservation of resources that would otherwise be foregone in systems that lack such feature. More illustrative information will now be set forth regarding various optional architectures and uses in which the foregoing method may or may not be implemented, per the desires of the user. It should be noted that the following information is set forth for illustrative purposes and should not be construed as limiting in any manner. Any of the following features may be optionally incorporated with or without the other features described.

FIG. 3 is a flowchart of a method 300 for determining a threshold data amount, in accordance with an embodiment. As an option, the method 300 may be implemented in the context of any one or more of the embodiments set forth in any previous and/or subsequent figure(s) and/or the description thereof. For example, in one possible embodiment, the method 300 may be carried out in the context of the step 202 of FIG. 2. However, it is to be appreciated that the method 300 may be implemented in the context of any desired environment.

To facilitate an understanding of the method 300, reference will be simultaneously made to FIG. 4, where FIG. 4 illustrates a connection set up process 400 involving an optimal path 402 and a non-optimal path 404 having various parameters including RTT values 403 that are used for determining a threshold data amount in accordance with the method 300 of FIG. 3. As shown, such RTT values 403 relate to a round trip time between various connection set up signals and, more particularly in the case of the optimal path 402, a synchronize (SYN) packet 406, a synchronize/acknowledgement (SYN/ACK) packet 408, an ACK+DATA transmission 410, and a ACK packet 412. Further, in the case of the non-optimal path 404, the RTT values 403 relate to a round trip time between various connection set up signals including a SYN-JOIN packet 414, a SYN/ACK(JOIN) packet 416, an ACK(JOIN) packet 418, and a WIN UPDATE packet 420.

As shown, in contrast to the setup of the optimal path 402, the setup of the non-optimal path 404 lacks any data transmission and includes a WIN UPDATE packet 420 in accordance with Sections 3.1-3.2 of the Request for Comments (RFC) 6 of the Internet Engineering Task Force (IETF). The reason for this difference in the setup of the optimal path 402 and the non-optimal path 404 is that, for the optimal path 402, when a TCP connection is set up, a client is permitted to send data once the SYN/ACK is received from the server. To this end, data may be sent together with an ACK packet (as shown) or separately. However, for the non-optimal path 404, when an additional subflow needs to be added, the sender/client waits for authentication to finish via the receipt of the two ACKs, before sending data (as shown). In any case, any one or more features of the various embodiments described herein may be incorporated with multipath TCP (MPTCP) of the IETF Multipath TCP working group, whose purpose is to ensure that TCP connections are capable of using multiple paths to maximize resource usage and increase redundancy.

Returning to FIG. 3 and operations 302-304 thereof, an optimal path RTT value of an optimal path and at least one non-optimal path RTT value of at least one non-optimal path, are respectively identified (e.g. see the RTT values 403 of FIG. 4). During a first iteration of the method 300 (when a system is first operated), such RTT values may be identified via a setting of an application policy (e.g. the application policies 108 of FIG. 1). For example, a system administrator or designer may set such RTT values for use when a system is first used by creating default estimated RTT values that are based on a design of the system and expected paths.

Strictly as an option, such RTT values (and thus the threshold data amount determination) may be further based on information on at least one application (e.g. the application 104 of FIG. 1). For example, the RTT values may vary because of path conditions changing when, for instance, a path becomes more congested (resulting in larger RTT values). Further, as will become apparent later, during subsequent iterations of the method 300, the foregoing RTT values may reflect actual measurements of live varying system operation and may thus be updated accordingly.

For further supporting the ultimate threshold data amount determination, an optimal path set up time (e.g. see the optimal path set up time 426 of FIG. 4) for the optimal path is calculated in operation 306, based on the optimal path RTT value. Specifically, such optimal path set up time is calculated by multiplying the optimal path RTT value by a factor of two (2). Further, a non-optimal path set up time (e.g. see the non-optimal path set up time 428 of FIG. 4) for the non-optimal path is calculated in operation 308, based on the non-optimal path RTT value. Again, such non-optimal path set up time is calculated by multiplying the non-optimal path RTT value by a factor of two (2).

Still yet, for reasons that will soon become apparent, an optimal path bandwidth of the optimal path is identified in operation 310. This may be accomplished in any desired manner including, but not limited to the use of testing measurements, etc. For example, in one embodiment, the bandwidth may be calculated as a total number of bytes sent/received during a RTT, divided by the corresponding RTT value. With continuing reference to FIG. 3, a start time when data communication starts utilizing the optimal path (e.g. see optimal path data start time 430 of FIG. 4) is identified in operation 312. Such start time may be when one or more initial data packets are sent during the optimal path setup process, as shown.

Equipped with this information, the threshold data amount may be determined in operation 314 to be an amount of data that is capable of being communicated utilizing the optimal path after the start time (e.g. see optimal path data start time 430 of FIG. 4) and during the non-optimal path set up time (e.g. see the non-optimal path set up time 428 of FIG. 4), up until a start time when data communication starts utilizing the non-optimal path (e.g. see non-optimal path data start time 432 of FIG. 4). Further, in one possible embodiment, such threshold data amount may be calculated by multiplying: 1) the time spanning between the data start time and an end of the non-optimal path set up time (i.e. the non-optimal path data start time), by 2) the bandwidth identified in operation 310. To this end, such threshold data amount may be used to determine whether to set up and use a non-optimal path in addition to an optimal path (e.g. see the method 200 of FIG. 2). In embodiments where multiple non-optimal paths exist, the forgoing may be carried out for each non-optimal path, where a separate threshold data amount exists for each non-optimal path.

After an initial calculation of the threshold data amount, the RTT values (that formed the basis for such initial calculation) may be updated per decision 316 based on changing network conditions. For example, link damage or failures may result in a change in such RTT values which may, in turn, result in a change in the threshold data amount. To this end, such RTT values may be updated by a scheduler (e.g. the multi-path scheduler 116 of FIG. 1) and further stored in operation 318 in an appropriate database (e.g. the RTT database 110 of FIG. 1) for use in connection with subsequent calculations of the threshold data amount by an appropriate system component (e.g. the path calculation engine 114 of FIG. 1). By this design, the threshold data amount determination (and subsequent control of the non-optimal path, e.g. the operations 206/208 of FIG. 2) may be dynamically updated.

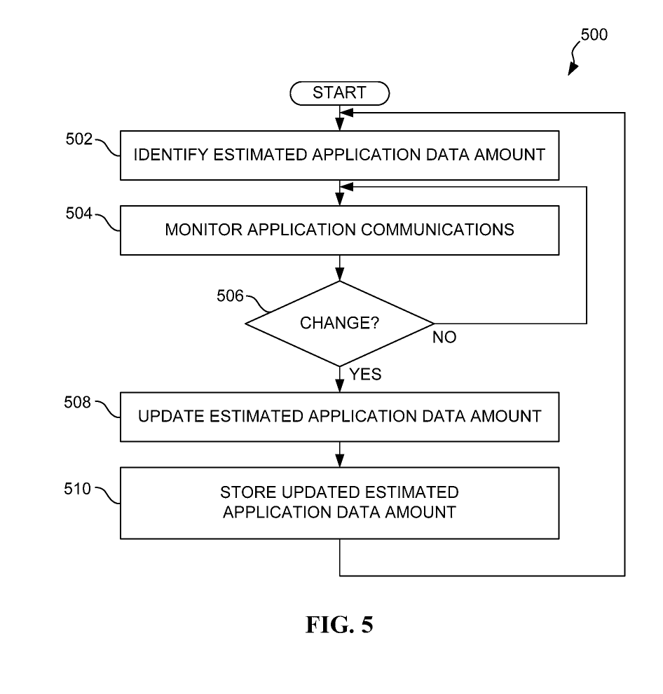

FIG. 5 is a flowchart of a method 500 for estimating an amount of data that will be communicated by an application, in accordance with an embodiment. As an option, the method 500 may be implemented in the context of any one or more of the embodiments set forth in any previous and/or subsequent figure(s) and/or the description thereof. In one embodiment, the method 500 may be implemented in the context of step 204 of FIG. 2. However, it is to be appreciated that the method 500 may be implemented in the context of any desired environment.

As shown in operation 502, an amount of data that will be communicated by an application (i.e. the estimated application data amount) may be identified. During a first iteration of the method 500 (when a system is first operated), such estimated application data amount may be identified via a setting of an application policy (e.g. the application policies 108 of FIG. 1). For example, a system administrator or designer may set such estimated application data amount for use when a system is first used by creating a default estimated application data amount for each of a plurality of applications that are expected to be used. To this end, such default estimated application data amount may be identified by looking up the same in a look up table populated with the foregoing information. Further, as will become apparent later, during subsequent iterations of the method 500, the estimated application data amount may reflect actual data communications of one or more applications during live varying system operation and may thus be updated accordingly.

Specifically, in operation 504, various operating applications may be monitored for identifying patterns in terms of an amount of data that is communicated by such applications. To this end, the estimated application data amount may be estimated based on pattern learning. For example, keep alive messages for some application may be short, and thus a data amount may be estimated accordingly. In contrast, a video conversation application may be known to generate a sizeable amount of data, and therefore it can be estimated that more data will be communicated. In other embodiments, identification of the foregoing estimated application data amount may involve an inspection of a condition of a transport control protocol (TCP) receive buffer, for determining how much data is actually being communicated (for future estimation purposes).

Further, to the extent that previously stored estimated application data amount associated with a particular application has changed per decision 506, such estimated application data amount may be updated and stored in operations 508-510, respectively. To this end, such estimated application data amount may be updated in operation 508 by a scheduler (e.g. the multi-path scheduler 116 of FIG. 1) and further stored in operation 510 in an appropriate database (e.g. the application data amount estimator/database 112 of FIG. 1) for use in connection with non-optimal path usage control by an appropriate system component (e.g. the multi-path scheduler 116 of FIG. 1). By this design, the control of the non-optimal path (e.g. the operations 206/208 of FIG. 2) may be dynamically updated based on new estimations of the application data amount.

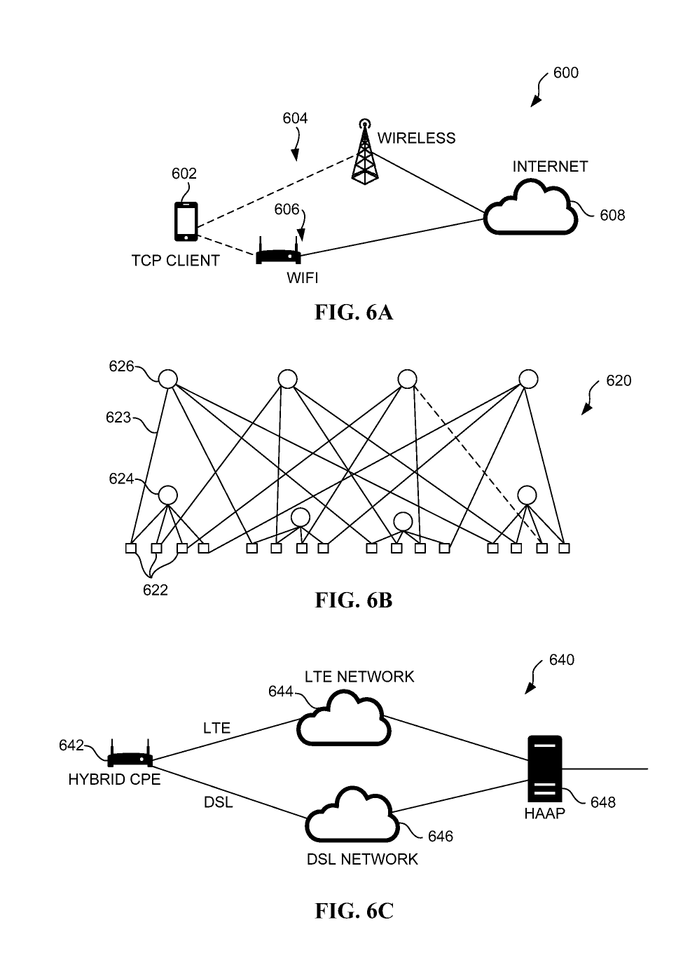

FIG. 6A illustrates a first system 600 in which usage of a non-optimal path may be controlled, in accordance with an embodiment. As shown, the first system 600 includes a TCP client 602 that may take the form of a phone, tablet, etc. that is capable of communicating via a first path 604 including a cellular connection and a via a second path 606 including a wireless or WiFi connection, for the purpose of communicating with a destination over a network 608 including, but not limited to the Internet. In use, the second path 606 may be determined to be an optimal path (based on superior RTT values), while the first path 604 may thus be determined to be a non-optimal path (based on inferior RTT values). During use, an amount of data to be communicated by the TCP client 602 may be estimated and then compared to a threshold data amount to determine whether to use the first path 604 when communicating data from the TCP client 602 via a multi-path approach.

FIG. 6B illustrates a second system 620 in which usage of a non-optimal path may be controlled, in accordance with another embodiment. As shown, the second system 620 includes a plurality of servers 622 that are components of a data center or the like, where the servers 622 are capable of communicating via different paths 623 that each utilize different combinations of leaf switches 624 and spine switches 626. In use, a first one of the paths 623 that pass solely through the leaf switches 624 may be determined to be an optimal path (based on superior RTT values), while remaining paths may thus be determined to be a non-optimal path (based on inferior RTT values). During use, an amount of data to be communicated by one of the servers 622 may be estimated and then compared to a threshold data amount to determine whether to use the first path when communicating data between the servers 622 via a multi-path approach.

FIG. 6C illustrates a third system 640 in which usage of a non-optimal path may be controlled, in accordance with yet another embodiment. As shown, the third system 640 includes hybrid customer premises equipment (CPE) 642 that may take the form of a wireless router that is capable of communicating via a first path 644 including a cellular long term evolution (LTE) connection and via a second path 646 including a digital subscriber line (DSL) connection, for the purpose of communicating with a destination hybrid access aggregation point (HAAP) 648. In use, the second path 646 may be determined to be an optimal path (based on superior RTT values), while the first path 644 may thus be determined to be a non-optimal path (based on inferior RTT values). During use, an amount of data to be communicated by the CPE 642 may be estimated and then compared to a threshold data amount to determine whether to use the first path 644 when communicating data from the CPE 642 via a multi-path approach.

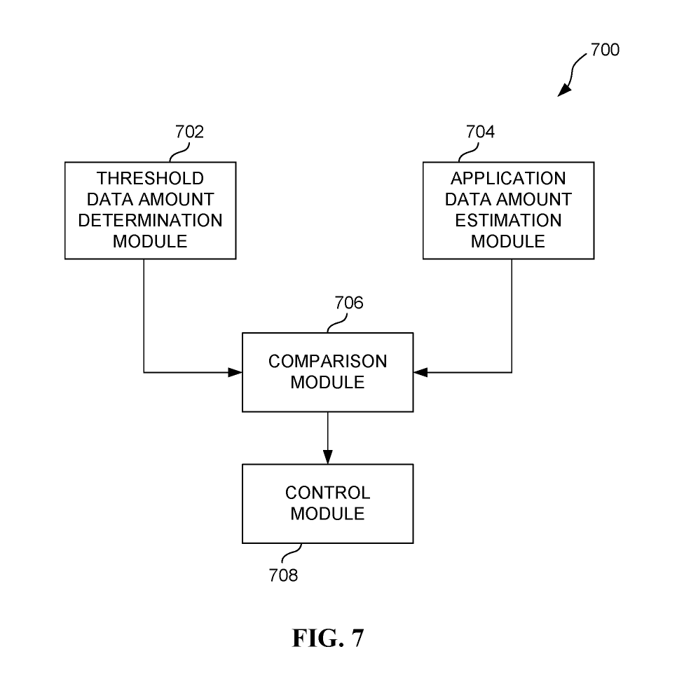

FIG. 7 illustrates a path control system 700 for controlling usage of at least one non-optimal path, in accordance with an embodiment. As an option, the path control system 700 may be implemented with one or more features of any one or more of the embodiments set forth in any previous and/or subsequent figure(s) and/or the description thereof. However, it is to be appreciated that the path control system 700 may be implemented in the context of any desired environment.

As shown, a threshold data amount determination means in the form of a threshold data amount determination module 702 is provided for determining a threshold data amount in connection with at least one non-optimal path, based on an optimal path RTT value of an optimal path and at least one non-optimal path RTT value of the at least one non-optimal path (e.g. see step 202 of FIG. 2, etc.). In various embodiments, the threshold data amount determination module 702 may include, but is not limited to the path calculation engine 114 of FIG. 1, at least one processor (to be described later) and any software controlling the same, and/or any other circuitry capable of the aforementioned functionality.

Also included is an application data amount estimation means in the form of an application data amount estimation module 704 for estimating an application data amount in connection with messages of at least one application (e.g. see step 204 of FIG. 2, etc.). In various embodiments, the application data amount estimation module 704 may include, but is not limited to the application data amount estimator/database 112 of FIG. 2, at least one processor (to be described later) and any software controlling the same, and/or any other circuitry capable of the aforementioned functionality.

With continuing reference to FIG. 7, comparison means in the form of a comparison module 706 is in communication with the threshold data amount determination module 702 and the application data amount estimation module 704 for comparing the application data amount and the threshold data amount (e.g. see step 206 of FIG. 2, etc.). In various embodiments, the comparison module 706 may include, but is not limited to the path calculation engine 114 of FIG. 1, at least one processor (to be described later) and any software controlling the same, and/or any other circuitry capable of the aforementioned functionality.

Still yet, control means in the form of a control module 708 is in communication with the comparison module 706 for controlling usage of the at least one non-optimal path for communicating the messages of the at least one application, based on the comparison of the application data amount and the threshold data amount (e.g. see step 208 of FIG. 2, etc.). In various embodiments, the control module 708 may include, but is not limited to the multi-path scheduler 116 of FIG. 1, at least one processor (to be described later) and any software controlling the same, and/or any other circuitry capable of the aforementioned functionality.

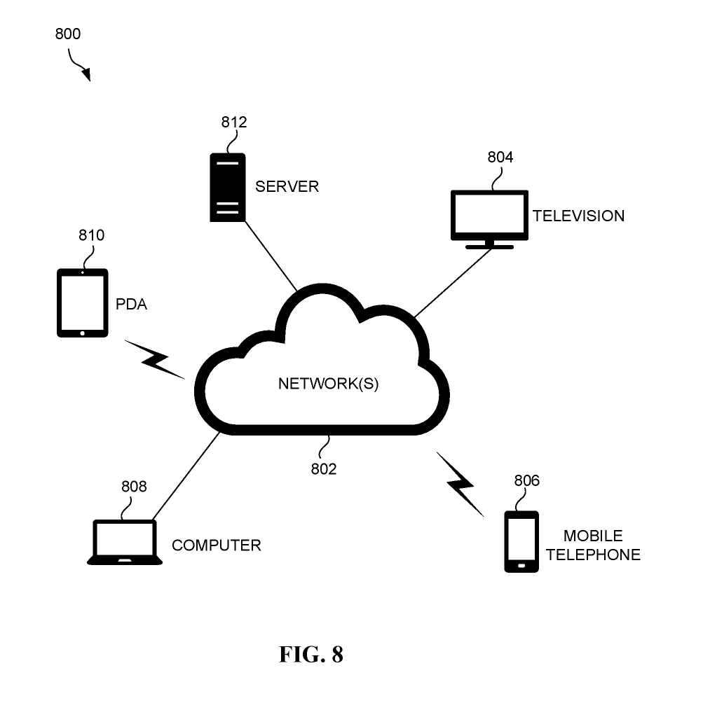

FIG. 8 is a diagram of a network architecture 800, in accordance with an embodiment. As shown, at least one network 802 is provided. In various embodiments, any one or more components/features set forth during the description of any previous figure(s) may be implemented in connection with any one or more components 804-812 coupled to the at least one network 802. For example, in various embodiments, any of the components 804-812 may be equipped with the path controller apparatus 102 of FIG. 1 for communicating messages of a resident application.

In the context of the present network architecture 800, the network 802 may take any form including, but not limited to a telecommunications network, a local area network (LAN), a wireless network, a wide area network (WAN) such as the Internet, peer-to-peer network, cable network, etc. While only one network is shown, it should be understood that two or more similar or different networks 802 may be provided.

Coupled to the network 802 is a plurality of devices. For example, a server 812 and a computer 808 may be coupled to the network 802 for communication purposes. Such computer 808 may include a desktop computer, lap-top computer, and/or any other type of logic. Still yet, various other devices may be coupled to the network 802 including a personal digital assistant (PDA) device 810, a mobile phone device 806, a television 804, etc.

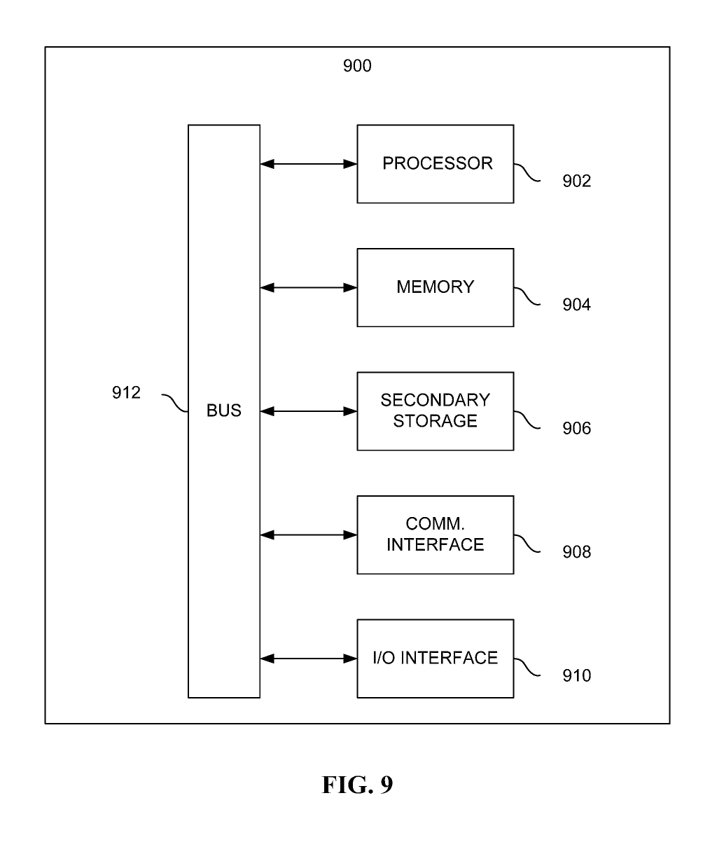

FIG. 9 is a diagram of an exemplary processing device 900, in accordance with an embodiment. As an option, the processing device 900 may be implemented in the context of any of the devices of the network architecture 800 of FIG. 8. However, it is to be appreciated that the processing device 900 may be implemented in any desired environment. For example, in various embodiments, the path controller apparatus 102 of FIG. 1 may be implemented on the processing device 900 for communicating messages of a resident application.

As shown, the processing device 900 includes at least one processor 902 which is connected to a bus 912 for processing data (e.g. see steps 202-208 of FIG. 2, etc.) The processing device 900 also includes memory 904 [e.g., hard disk drive, solid state drive, random access memory (RAM), etc.] coupled to the bus 912. The memory 904 may include one or more memory components, and may even include different types of memory. Further included is a communication interface 908 (e.g. a network adapter, modem, etc.) and an input/output (I/O) interface 910 (e.g. display, speaker, microphone, touchscreen, touchpad, mouse interface, etc.).

The processing device 900 may also include a secondary storage 906. The secondary storage 906 coupled to the bus 912 and/or to other components of the processing device 900. The secondary storage 906 can include, for example, a hard disk drive and/or a removable storage drive, representing a floppy disk drive, a magnetic tape drive, a compact disk drive, etc. The removable storage drive reads from and/or writes to a removable storage unit in a well-known manner.

Computer programs, or computer control logic algorithms, may be stored in the memory 904, the secondary storage 906, and/or any other memory, for that matter. Such computer programs, when executed, enable the processing device 900 to perform various functions (as set forth above, for example). Memory 904, secondary storage 906 and/or any other storage comprise non-transitory computer-readable media.

In one embodiment, the at least one processor 902 executes instructions in the memory 904 or in the secondary storage 906 to control usage of at least one non-optimal path (e.g. via the communication interface 908, etc.), by: determining a threshold data amount in connection with at least one non-optimal path, based on an optimal path RTT value of an optimal path and at least one non-optimal path RTT value of the at least one non-optimal path; estimating an application data amount in connection with messages of at least one application; comparing the application data amount and the threshold data amount; and controlling usage of the at least one non-optimal path for communicating the messages of the at least one application, based on the comparison of the application data amount and the threshold data amount.

In some embodiments, the determination of the threshold data amount for the at least one non-optimal path may be further based on information on the at least one application.

In some embodiments, the application data amount may be estimated utilizing pattern learning.

In some embodiments, the usage of the at least one non-optimal path may be controlled by: setting up the at least one non-optimal path for communicating the messages of the at least one application, and/or terminating the at least one non-optimal path for communicating the messages of the at least one application.

In some embodiments, the application data amount may be updated, where the control of the usage of the at least one non-optimal path may also be updated, based on the updated application data amount.

In some embodiments, the threshold data amount may be updated, where the control of the usage of the at least one non-optimal path may also be updated, based on the updated threshold data amount.

In some embodiments, the threshold data amount may be updated based on at least one updated optimal path RTT value of the optimal path and at least one updated non-optimal path RTT value of the non-optimal path.

In some embodiments, the at least one optimal path RTT value of the optimal path and the at least one non-optimal path RTT value may be initially set based on a policy.

In some embodiments, the threshold data amount may be determined by: calculating a non-optimal path setup time for the at least one non-optimal path based on the at least one non-optimal path RTT value of the at least one non-optimal path; identifying an optimal path bandwidth of the optimal path; and determining the threshold data amount to be at least an amount of data that is capable of being communicated utilizing the optimal path during the non-optimal path setup time.

It is noted that the techniques described herein, in an aspect, are embodied in executable instructions stored in a computer readable medium for use by or in connection with an instruction execution machine, apparatus, or device, such as a computer-based or processor-containing machine, apparatus, or device. It will be appreciated by those skilled in the art that for some embodiments, other types of computer readable media are included which may store data that is accessible by a computer, such as magnetic cassettes, flash memory cards, digital video disks, Bernoulli cartridges, random access memory (RAM), read-only memory (ROM), or the like.

As used here, a “computer-readable medium” includes one or more of any suitable media for storing the executable instructions of a computer program such that the instruction execution machine, system, apparatus, or device may read (or fetch) the instructions from the computer readable medium and execute the instructions for carrying out the described methods. Suitable storage formats include one or more of an electronic, magnetic, optical, or electromagnetic format. A non-exhaustive list of conventional exemplary computer readable medium includes: a portable computer diskette; a RAM; a ROM; an erasable programmable read only memory (EPROM or flash memory); optical storage devices, including a portable compact disc (CD), a portable digital video disc (DVD), a high definition DVD (HD-DVD™), a BLU-RAY disc; or the like.

It should be understood that the arrangement of components illustrated in the Figures described are exemplary and that other arrangements are possible. It should also be understood that the various system components defined by the claims, described below, and illustrated in the various block diagrams represent logical components in some systems configured according to the subject matter disclosed herein.

For example, one or more of these system components may be realized, in whole or in part, by at least some of the components illustrated in the arrangements illustrated in the described Figures. In addition, while at least one of these components are implemented at least partially as an electronic hardware component, and therefore constitutes a machine, the other components may be implemented in software that when included in an execution environment constitutes a machine, hardware, or a combination of software and hardware.

More particularly, at least one component defined by the claims is implemented at least partially as an electronic hardware component, such as an instruction execution machine (e.g., a processor-based or processor-containing machine) and/or as specialized circuits or circuitry (e.g., discrete logic gates interconnected to perform a specialized function). Other components may be implemented in software, hardware, or a combination of software and hardware. Moreover, some or all of these other components may be combined, some may be omitted altogether, and additional components may be added while still achieving the functionality described herein. Thus, the subject matter described herein may be embodied in many different variations, and all such variations are contemplated to be within the scope of what is claimed.

In the description above, the subject matter is described with reference to acts and symbolic representations of operations that are performed by one or more devices, unless indicated otherwise. As such, it will be understood that such acts and operations, which are at times referred to as being computer-executed, include the manipulation by the processor of data in a structured form. This manipulation transforms the data or maintains it at locations in the memory system of the computer, which reconfigures or otherwise alters the operation of the device in a manner well understood by those skilled in the art. The data is maintained at physical locations of the memory as data structures that have particular properties defined by the format of the data. However, while the subject matter is being described in the foregoing context, it is not meant to be limiting as those of skill in the art will appreciate that various of the acts and operations described hereinafter may also be implemented in hardware.

To facilitate an understanding of the subject matter described herein, many aspects are described in terms of sequences of actions. At least one of these aspects defined by the claims is performed by an electronic hardware component. For example, it will be recognized that the various actions may be performed by specialized circuits or circuitry, by program instructions being executed by one or more processors, or by a combination of both. The description herein of any sequence of actions is not intended to imply that the specific order described for performing that sequence must be followed. All methods described herein may be performed in any suitable order unless otherwise indicated herein or otherwise clearly contradicted by context.

The use of the terms “a” and “an” and “the” and similar referents in the context of describing the subject matter (particularly in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. Furthermore, the foregoing description is for the purpose of illustration only, and not for the purpose of limitation, as the scope of protection sought is defined by the claims as set forth hereinafter together with any equivalents thereof entitled to. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

The embodiments described herein include the one or more modes known to the inventor for carrying out the claimed subject matter. It is to be appreciated that variations of those embodiments will become apparent to those of ordinary skill in the art upon reading the foregoing description. The inventor expects skilled artisans to employ such variations as appropriate, and the inventor intends for the claimed subject matter to be practiced otherwise than as specifically described herein. Accordingly, this claimed subject matter includes all modifications and equivalents of the subject matter recited in the claims appended hereto as permitted by applicable law. Moreover, any combination of the above-described elements in all possible variations thereof is encompassed unless otherwise indicated herein or otherwise clearly contradicted by context.

What is claimed is:

1. A processing device, comprising:
a non-transitory memory storing instructions, and a plurality of round trip time (RTT) values of a plurality of paths; and
one or more processors in communication with the non-transitory memory, wherein the one or more processors execute the instructions to:
identify one of the plurality of paths as an optimal path based on the plurality of RTT values, where the RTT values include an optimal path RTT value of the optimal path and at least one non-optimal path RTT value of at least one non-optimal path;
determine a threshold data amount in connection with the at least one non-optimal path, based on the optimal path RTT value of the optimal path and the at least one non-optimal path RTT value of the at least one non-optimal path;
estimate an application data amount in connection with messages of at least one application;
compare the application data amount and the threshold data amount; and
control usage of the at least one non-optimal path for communicating the messages of the at least one application, based on the comparison of the application data amount and the threshold data amount.

2. The processing device of claim 1, wherein the determination of the threshold data amount for the at least one non-optimal path is further based on information on the at least one application.

3. The processing device of claim 1, wherein the application data amount is estimated utilizing at least one of pattern learning or a condition of a transport control protocol (TCP) receive buffer.

4. The processing device of claim 1, wherein the usage of the at least one non-optimal path is controlled by at least one of: setting up the at least one non-optimal path, or terminating the at least one non-optimal path.

5. The processing device of claim 1, wherein the one or more processors execute the instructions to:
update the application data amount; and
update the control of the usage of the at least one non-optimal path, based on the updated application data amount.

6. The processing device of claim 1, wherein the one or more processors execute the instructions to:
update the threshold data amount; and
update the control of the usage of the at least one non-optimal path, based on the updated threshold data amount.

7. The processing device of claim 6, wherein the threshold data amount is updated based on at least one updated optimal path RTT value of the optimal path and at least one updated non-optimal path RTT value of the non-optimal path.

8. The processing device of claim 1, wherein the RTT values of the plurality of paths are set based on a policy.

9. The processing device of claim 1, wherein the RTT values of the plurality of paths are set by at least one other application which has used at least one of the plurality of paths.

10. The processing device of claim 1, wherein the threshold data amount is determined by:
calculating a non-optimal path setup time for the at least one non-optimal path based on the at least one non-optimal path RTT value of the at least one non-optimal path;
identifying an optimal path bandwidth of the optimal path; and
determining the threshold data amount to be at least an amount of data that is capable of being communicated utilizing the optimal path during the non-optimal path setup time.

11. A method, comprising:
a processing device identifying one of a plurality of paths as an optimal path based on a plurality of round trip time (RTT) values, where the RTT values include an optimal path round trip time (RTT) value of the optimal path and at least one non-optimal path RTT value of at least one non-optimal path;
the processing device determining a threshold data amount in connection with at least one non-optimal path, based on the optimal path RTT value of the optimal path and the at least one non-optimal path RTT value of the at least one non-optimal path;
the processing device estimating an application data amount in connection with messages of at least one application;
the processing device comparing the application data amount and the threshold data amount; and
the processing device controlling usage of the at least one non-optimal path for communicating the messages of the at least one application, based on the comparison of the application data amount and the threshold data amount.

12. The method of claim 11, wherein the determination of the threshold data amount for the at least one non-optimal path is further based on information on the at least one application.

13. The method of claim 11, wherein the application data amount is estimated utilizing at least one of pattern learning or a condition of a transport control protocol (TCP) receive buffer.

14. The method of claim 11, wherein the usage of the at least one non-optimal path is controlled by at least one of: setting up the at least one non-optimal path, or terminating the at least one non-optimal path.

15. The method of claim 11, and further comprising:
the processing device updating the application data amount; and
the processing device updating the control of the usage of the at least one non-optimal path, based on the updated application data amount.

16. The method of claim 11, and further comprising:
the processing device updating the threshold data amount; and
the processing device updating the control of the usage of the at least one non-optimal path, based on the updated threshold data amount.

17. The method of claim 16, wherein the threshold data amount is updated based on at least one updated optimal path RTT value of the optimal path and at least one updated non-optimal path RTT value of the non-optimal path.

18. The method of claim 11, wherein the RTT values of the plurality of paths are set based on a policy.

19. The method of claim 11, wherein the RTT values of the plurality of paths are set by at least one other application which has used at least one of the plurality of paths.

20. The method of claim 11, wherein the threshold data amount is determined by:
the processing device calculating a non-optimal path setup time for the at least one non-optimal path based on the at least one non-optimal path RTT value of the at least one non-optimal path;
the processing device identifying an optimal path bandwidth of the optimal path; and
the processing device determining the threshold data amount to be at least an amount of data that is capable of being communicated utilizing the optimal path during the non-optimal path setup time.

21. A non-transitory computer-readable media storing computer instructions, that when executed by one or more processors, cause the one or more processors to perform the steps of:
identifying one of a plurality of paths as an optimal path based on a plurality of round trip time (RTT) values, where the RTT values include an optimal path round trip time (RTT) value of the optimal path and at least one non-optimal path RTT value of at least one non-optimal path;
determining a threshold data amount in connection with the at least one non-optimal path, based on the optimal path RTT value of the optimal path and the at least one non-optimal path RTT value of the at least one non-optimal path;
estimating an application data amount in connection with messages of at least one application;
comparing the application data amount and the threshold data amount; and
controlling usage of the at least one non-optimal path for communicating the messages of the at least one application, based on the comparison of the application data amount and the threshold data amount.

22. The non-transitory computer-readable media of claim 21, wherein the computer instructions, when executed by the one or more processors, cause the one or more processors to perform the steps of:
calculating a non-optimal path setup time for the at least one non-optimal path based on the at least one non-optimal path RTT value of the at least one non-optimal path;
identifying an optimal path bandwidth of the optimal path; and
determining the threshold data amount to be at least an amount of data that is capable of being communicated utilizing the optimal path during the non-optimal path setup time.
